(19) United States
(12) Patent Application Publication
(10) Pub. No.: US 2007/0061126 A1
(43) Pub. Date: Mar. 15, 2007

(54) System for and method of emulating electronic input devices

(76) Inventors: Anthony Russo, New York, NY (US); Frank Chen, San Jose, CA (US); Mark Howell, Glendale, AZ (US); Hung Ngo, San Jose, CA (US); Marcia Tsuchiya, Fremont, CA (US); David Weigand, Santa Clara, CA (US)

Correspondence Address: HAVERSTOCK & OWENS LLP, 162 NORTH WOLFE ROAD, SUNNYVALE, CA, 94086, US

(21) Appl. No.: 11/219,100

(22) Filed: Sep. 1, 2005

(51) Int. Cl. G06F 9/455

(52) U.S. Cl. 703/24

(57) ABSTRACT

The system and method of the present invention is directed to emulating and configuring any of a plurality of electronic input devices. A system in accordance with one embodiment of the present invention comprises an interface and an emulator. The interface is for selecting and configuring an electronic input device from a plurality of electronic input devices, and the emulator is for emulating the electronic input device. Preferably, the plurality of electronic input devices comprise any two or more of a scroll wheel, a mouse, a joy stick, a steering wheel, an analog button, and a touch bar. Also in a preferred embodiment, the interface is an Application Programming Interface (API) and the emulator comprises a finger swipe sensor for receiving user input.

### FIELD OF THE INVENTION

The present invention relates to electronic input devices. More particularly, the present invention relates to systems for and methods of selecting and configuring one of a plurality of electronic input devices for emulation.

### BACKGROUND OF THE INVENTION

Because they have a small footprint, finger sensors are finding an increasing number of uses on electronic platforms. In some systems, for example, finger sensors authenticate users before allowing them access to computer resources. In other systems, finger sensors are used to control a cursor on a computer screen. No prior art system, however, is configured to perform the functions of multiple input devices.

One prior art system combines authentication and cursor control. U.S. Patent Pub. No. 2002/0054695 A1, titled “Configurable Multi-Function Touchpad Device,” to Bjorn et al. discloses a multi-function touchpad device. The device uses an image of one portion of a user's finger for authentication and the image of another portion of the user's finger for cursor control. When an image of a full fingerprint is captured on a surface of the touch pad device, the touch pad device operates as an authentication device; when an image of only a fingertip is captured, the touch pad device operates as a pointer control device.

The invention disclosed in Bjorn et al. is limited. It can be used to emulate only a pointer control device. Moreover, it cannot use the same finger image to perform different functions, and it cannot be customized.

### SUMMARY OF THE INVENTION

The present invention is directed to systems for and methods of using a computer input device to selectively emulate other computer input devices. Systems in accordance with the present invention can thus be used to select and configure an input device that better suits the application at hand, doing so with a footprint smaller than that of prior art devices.

In a first aspect of the present invention, a system comprises an interface for selecting an electronic input device from a plurality of electronic input devices and an emulator coupled to the interface for emulating the electronic input device. Preferably, the interface comprises an application programming interface (API) that provides a set of functions that can be used to select, configure, and tune any one of a plurality of input devices to be emulated. Preferably, the set of functions includes a function for selecting a device type corresponding to the input device to be emulated. The device type is any electronic input device including a mouse, a scroll wheel, a joystick, a steering wheel, an analog button, a digital button, a pressure sensor, and a touch bar, to name a few examples among many. As described below, an enroll type ,a verify type, and an identify type are also considered as electronic input devices when the physical device used in one embodiment of the invention is a finger sensor.

In one embodiment, the set of functions includes a function for setting a characteristic of the electronic input device. The characteristic is any one of a type of motion, a set of capabilities, a mapping of an input of a physical device to an output of the electronic input device, and a setting for tuning a parameter of the electronic input device. The parameter of the electronic device is any one of a multitude of settings that affect the behavior of the device, including scaling in a linear direction, scaling in an angular direction, smoothing of the user's motion, and fixing how quickly the emulated joystick returns to center after the finger is lifted. The type of motion comprises any one or more of a motion in a linear direction only (e.g., x-only or y-only), a motion in a predetermined number of linear directions only (e.g., x-only and y-only), and a motion corresponding to a geometric shape, such as a circle, a rectangle, a square, a triangle, an arbitrary shape such as found in a standard alphabet, and a periodic shape. The set of capabilities includes any one or more of a mouse button operation, a drag-and-drop operation, a pressure, a rotation, a rate mode in a linear direction, and a rate mode in an angular direction.

In one embodiment, the input to the physical device is any one of a motion in a first linear direction and a gesture, and the output of the electronic input device is any one of a motion in a second linear direction, a motion in an angular direction, and a mouse button operation.

In one embodiment, the system further comprises a physical device coupled to the interface. The physical device receives an input (such as a finger swipe, when the physical device is a finger sensor) and generates an output, which is later translated to an output corresponding to the output of the emulated electronic input device (such as a mouse click, when the emulated electronic input device is a mouse). Preferably, the physical device comprises a finger sensor, such as a fingerprint swipe sensor. The finger swipe sensor is any one of a capacitive sensor, a thermal sensor, and an optical sensor. Alternatively, the finger sensor is a finger placement sensor. In still alternative embodiments, the physical device is any one of a track ball, a scroll wheel, a touch pad, a joystick, and a mouse, to name a few physical devices.

In one embodiment, the physical device is configured to receive a gesture, whereby the generated output corresponds to any one of a change to a device type, a change to a freedom of motion, a change to the tuning of the emulated device, a character, and a control signal for operating a host device coupled to the emulator. In one embodiment, operating the host device comprises launching a software program on the host device. A gesture is typically a simple, easily recognizable motion, such as the tracing of a finger along the surface in a fairly straight line, which the system of the present invention is configured to receive, recognize, and process. However, gestures can be more complex as well, including among other things, the tracing of a finger along a surface of a finger sensor in the shape of (a) a capital “U”, (b) a lowercase “u”, (c) the spelling of a pass phrase, or (d) any combination of characters, symbols, punctuation marks, etc.

In one embodiment, the interface further comprises a graphical user interface for invoking the functions. Alternatively, the interface comprises a command line interface, a voice-operable interface, or a touch-screen interface.

In one embodiment, the system further comprises a host device for receiving an output of the electronic input device. The host device is a personal computer, a personal digital assistant, a digital camera, an electronic game, a printer, a photo copier, a cell phone, a digital video disc player, or a digital audio player.

In a second aspect of the present invention, a system comprises means for selecting an electronic input device from a plurality of electronic input devices and means for emulating the electronic input device.

In a third aspect of the present invention, a system comprises a physical device for receiving a gesture and a translator coupled to the physical device. The translator translates the gesture into a selectable one of an output of an electronic input device and a defined entry.

In a fourth aspect of the present invention, a method of generating an input for an electronic device comprises performing a gesture on a physical device and translating the gesture into a selectable one of an output of an electronic input device and a defined entry.

In a fifth aspect of the present invention, a method of emulating an electronic input device comprises selecting an electronic input device from a plurality of electronic input devices, receiving an input on a physical device, and translating the input from the physical device to an output corresponding to the electronic input device, thereby emulating the electronic input device.

### BRIEF DESCRIPTION OF THE DRAWINGS

FIG. 1 shows a user tapping his finger on a finger sensor to selectively emulate a mouse click in accordance with the present invention.

FIG. 2 is a table showing a list of functions and their corresponding parameters for implementing an application programming interface (API) in a preferred embodiment of the present invention.

FIG. 3 shows a state diagram for selecting and configuring input devices emulated in accordance with the present invention.

FIG. 4 shows a finger sensor and a display screen displaying a text area and a graphical user interface, after selecting that the finger sensor emulates a scroll wheel in accordance with the present invention.

FIG. 5 shows the finger sensor and display screen in FIG. 4, after selecting that the finger sensor emulates a mouse for highlighting portions of text within the text area in accordance with the present invention.

FIG. 6 shows a display screen displaying a graphical user interface for selecting one of a plurality of input devices to emulate in accordance with the present invention.

FIG. 7 shows examples of simple gestures made on a physical input device for mapping to outputs generated by an emulated electronic input device in accordance with the present invention.

FIG. 8 shows examples of more complex gestures made on a physical input device for mapping to outputs generated by an emulated electronic input device in accordance with the present invention.

FIGS. 9A-C show several shapes generated using a device emulator in accordance with the present invention.

FIGS. 10A-B show components used for selectively emulating any one of a number of electronic input devices in accordance with the present invention.

### DETAILED DESCRIPTION OF THE PREFERRED EMBODIMENT

In accordance with the present invention, any one of a number of computer input devices are able to be emulated and configured. In accordance with one embodiment of the invention, output signals from an actual, physical device are translated into signals corresponding to a different device (called an “emulated” or “virtual” device). An application program or other system that receives the translated signals functions as if it is coupled to and thus has received outputs from the different device. By selecting from among any number of devices to emulate, systems and applications coupled to the physical device can function as if they are an input device coupled to any number of emulated devices.

As one example, a programmer writing an application can use an interface to select different devices to be emulated for different modes of program operation. Using an interface designed using the invention, a user running a game program on a system is able to use an interface to select that a finger sensor, the actual physical input device, functions as a joy stick. Alternatively, a software package (such as a plug-in module), once installed on the system, is able to use the interface to automatically select, without user intervention, that the finger sensor functions as a joy stick.

Using the same interface, a user on the system, now running a computer-aided design (CAD) program, is able to select that the finger sensor functions as a scroll wheel. Still using the same interface, when the system runs a word processing program, the finger sensor is selected to function as a touch pad. In accordance with the present invention, application programmers and hence users are able to select how a computer input device functions, matching the operation of the input device to best fit the application at hand. By easily selecting and configuring an input device that best matches the application they are using, users are thus more productive. Additionally, because a single computer input device is able to replace multiple other input devices, the system is much smaller and thus finds use on portable electronic devices.

The system and method in accordance with the present invention find use on any electronic devices that receive inputs from electronic input devices. The system and method are especially useful on systems that execute different applications that together are configured to receive inputs from multiple input devices, such as finger sensors, mice, scroll wheels, joy sticks, steering wheels, analog buttons, pressure sensors, and touch pads, to name a few. Electronic devices used in accordance with the present invention include personal computers, personal digital assistants, digital cameras, electronic games, printers, copiers, cell phones, digital video disc players, and digital audio players, such as an MP3 player. Many other electronic devices can benefit from the present invention.

While much of the discussion that follows describes finger sensors as the physical input device that the user manipulates, the emulation algorithms described below can be used with any number of physical input devices. In other embodiments, for example, the physical input device is a track ball that selectively emulates any one of a mouse, a steering wheel and a joy stick.

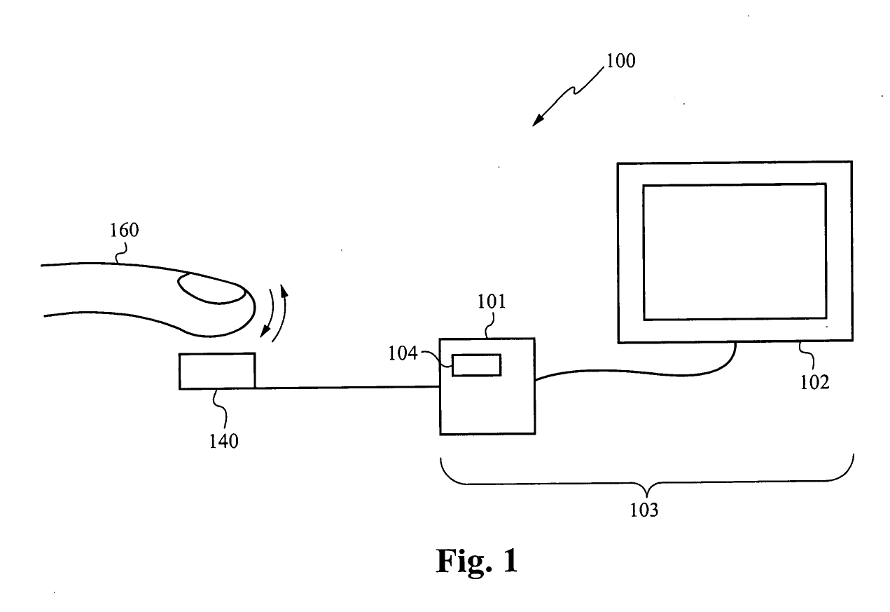

FIG. 1 shows a device emulation system 100 receiving input from a finger 160 in accordance with the present invention. The device emulation system 100 comprises a finger sensor 140 coupled to and configured to generate inputs for a computer system 103. The computer system 103 comprises a processing portion 101 and a display screen 102. As one example, the computer system 103 is able to execute a software program 104 configured to receive, recognize, and process mouse inputs. In one embodiment, the software program 104 is a word processing program that receives and processes mouse clicks to highlight and select portions of text displayed on the display screen 102. In this example, an application programming interface (API) interfaces the finger sensor 140 to the software program 104. The finger sensor 140 receives the input generated by a movement of the finger 160 on the finger sensor 140, and the API translates the output generated by the finger sensor 160 to a mouse click or other mouse operation for use by the software program 104. It will be appreciated that the API can be packaged to form part of the finger sensor 140, part of the computer system 103, or part of both. It will also be appreciated that the API can be implemented in software, hardware, firmware, or any combination of these.

As shown in FIG. 1, the tapping a surface of the finger sensor 104 by the finger 160, as shown by the pair of opposing curved arrows, generates an output from the finger sensor 104, which is translated by the API into outputs corresponding to a mouse click. In this example, the finger sensor 104 is said to emulate a mouse button. The outputs corresponding to the mouse click are input to the software program 104. As explained in more detail below, when the finger sensor 140 is used to emulate a mouse, other manipulations of the finger sensor 140 (e.g., tapping a left side of the finger sensor 140, tapping a right side of the finger sensor 140, tapping and keeping a finger relatively motionless on the finger sensor 140 for a pre-determined time, etc.) will be translated by the API into other mouse operations (e.g., a left-button click, a right-button click, and highlighting, respectively) input to the software program 104. When the API is configured so that the finger sensor 140 is used to emulate other selected input devices, these manipulations of the finger sensor 140 will be translated into input signals corresponding to the other selected emulated input devices.

Systems for and methods of emulating input devices are taught in U.S. patent Ser. No. 10/873,393, titled “System and Method for a Miniature User Input Device,” filed Jun. 21, 2004, and U.S. patent Ser. No. 11/056,820, titled “System and Method of Emulating Mouse Operations Using Finger Image Sensors,” filed Feb. 10, 2005, both of which are hereby incorporated by reference.

The device emulation system 100 is able to be configured in many ways to fit the application at hand. As one example, the software program 104 is a racing car driving simulator. The API is configured so that the outputs of the finger sensor 140 are translated into outputs generated by a steering wheel. When a user manipulates the finger sensor 140 in a pre-determined way, the API translates the outputs from the finger sensor 140 into an input that the software program 104 recognizes as outputs from a steering wheel, thereby allowing the simulated racing car to be steered or otherwise controlled.

Preferably, the API in accordance with the present invention is available to any number of software programs executing on the computer system 103. In one embodiment, the API is provided as a set of library functions that are accessible to any number of programs executing on the computer 103. In one example, software programs are linked to the API before or as they execute on the computer system 103. In this example, the API is customized for use by each of the software programs to provide inputs used by the software programs.

In some embodiments described in more detail below, the API is accessible through a graphical user interface (GUI). In these embodiments, a user is able to select a device to emulate, as well as parameters for emulating the device (e.g., degrees of freedom if the device is a track ball), through the GUI. Preferably, selecting or activating an area of the GUI directly calls a function within the API. In other embodiments, the API is accessible through a voice-operable module or using a touch screen.

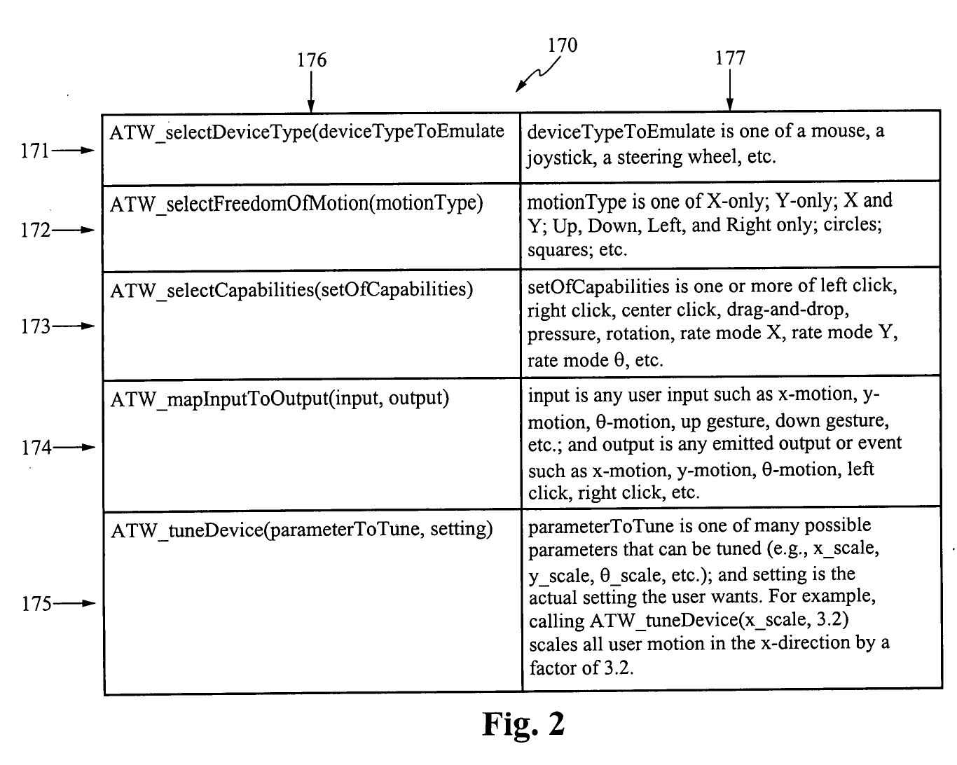

FIG. 2 shows a table 170 containing five functions that form an API upon which programs, graphical interfaces, touch-screens, and the like that use embodiments of the present invention can be built. The functions, which correspond to five aspects of the invention, include:
ATW_selectDeviceType(deviceTypeToEmulate);
ATW_selectFreedomOfMotion(motionType);
ATW_selectCapabilities(setOfCapabilities);
ATW_mapInputToOutput(input, output); and
ATW_tuneDevice(parameterToTune, setting).
   It will be appreciated by those skilled in the art that these functions can have different names, or that similar functionality can be implemented using any number of functions, even a single one.

The following discussion assumes that the physical device, which receives actual user input, is a finger sensor. This assumption is made merely to explain one embodiment of the present invention and is not intended to limit the scope of the invention. As explained above, many different physical devices are able to be used in accordance with the present invention.

The rows 171-175 of the table 170 each lists one of the five functions in column 176 and the corresponding parameters for each function in column 177. Referring to row 171, the column 176 contains an entry for the function ATW_selectDeviceType, which takes the parameter “deviceTypeToEmulate.” By setting deviceTypeToEmulate to an appropriate value, ATW_selectdeviceType can be called to set the type of device that the finger sensor 140 emulates. Column 177 in row 171 shows that deviceTypeToEmulate can be set to any one of a mouse, a joystick, a steering wheel, or other device such as described above. In other words, by setting deviceTypeToEmulate to “mouse”, the API will be configured so that the finger sensor 140 in FIG. 1 is used to emulate a mouse. That is, the API will translate the outputs generated by the finger sensor 140 into mouse click outputs, which are then received by the software program 104. It will be appreciated that the value of deviceTypeToEmulate can be a string, such as “mouse”; an integer coded into the function call or translated by a preprocessor from a definition into an integer; or any other combination of characters and symbols that uniquely identify a mouse as the device to be emulated.

Similarly, referring now to row 172, the column 176 shows an entry for the function ATW_selectFreedomOfMotion, which takes the parameter “motionType.” By setting motionType to the appropriate value, ATW_selectFreedomOfMotion can be called to set the freedom of movement of the emulated device. ATW_selectFreedomOfMotion can be called so that user inputs are translated into pre-determined paths, such as tracing out a geometric shape, such as a circle, a square, a character, a periodic shape, or parts thereof. For example, when the emulated device is a joystick, motionType can be set so that the emulated device will generate inputs for up and down movements only. Alternatively, motionType can be set so that the emulated device will generate outputs for generating x-only motions. Column 177 in row 172 shows that motionType can be set to any one of a linear motion, such as x-only; y-only; x and y; up, down, left, and right only. Additionally, motionType can be set to values corresponding to geometric figures such as circles, squares, triangles, ellipses, among others known from any elementary geometry text book. In this case, linear or rotational movement is able to be transformed into movement along the perimeter of any of these predetermined shapes.

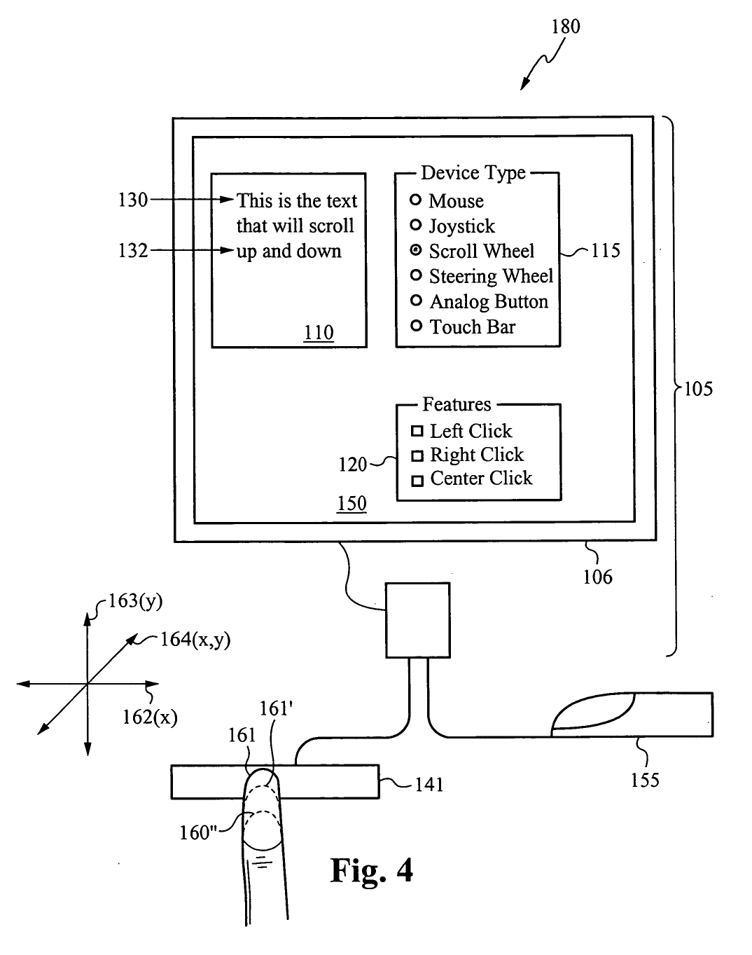

Referring now to row 173, the column 176 shows an entry for the function ATW_selectCapabilities, which takes the parameter “setOfCapabilities.” By setting setOfCapabilities to the appropriate value, ATW_selectCapabilities can be called to set the capabilities of the emulated device. For example, when the emulated device is a joystick, the setOfCapabilities can be set so that the emulated device is capable of generating motion in the x direction (i.e., a linear motion), motion in a diagonal direction (e.g., 164, FIG. 4), etc. Column 177 in row 173 shows that setOfCapabilities can be set to any one or more of left click, right click, center click, drag-and-drop (for example, when the emulated device is a mouse), pressure, rotation, rate mode X (e.g., the rate that an output is generated in the x-direction), rate mode Y, and rate mode θ, etc.

Referring now to row 174, the column 176 shows an entry for the function ATW_mapInputToOutput, which takes the parameters “input” and “output.” ATW_mapInputToOutput is called to set how motions made on the finger sensor 140 (inputs) are mapped to outputs that correspond to the emulated device. For example, by setting the values of “input” and “output” to pre-defined values, an input of an up-motion swipe (on the finger sensor) is mapped to an output corresponding to a left-button mouse click. Column 177 in row 174 shows that inputs can be set to the values x-motion, y-motion, θ-motion, up gesture (described in more detail below), down gesture, etc. Still referring to column 177 in row 174, these inputs can be mapped to any emitted output or event, such as x-motion, y-motion, θ-motion, left-click, right-click, etc.

Finally, referring to row 175, the column 176 shows an entry for the function ATW_tuneDevice, which takes the parameters “parameterToTune” and “setting.” ATW_tuneDevice is called to tune an emulated device. For example, an emulated device can be tuned so that its output is scaled, smoothed, or transposed. For example, if a user wants the emulated device to be tuned so that the length of the output (from the emulated device) in the x direction is 3.2 times that of the input (on the physical device), the value of parameterToTune is set to x_scale and the value of the parameter setting is set to 3.2. It will be appreciated that many input values can be scaled including, but not limited to, input values in the y direction, rotational input values (i.e., in the θ direction), etc. Reverse motion is able to be achieved using negative scale factors.

In a preferred embodiment, the API comprises a function or set of functions for selection of three characteristics of a given emulated device: the device type (e.g., joystick, mouse, etc.), the freedom of movement (e.g., x-only, y-only, pre-determined path, etc.), and the set of capabilities (e.g., left-button click, right-button click, drag-and-drop, etc.). In another embodiment, only the device type is selectable. In another embodiment, only the device type and freedom of movement are selectable. In still another embodiment, only the device type and the set of capabilities are selectable. In still another embodiment, the user input is one of a predefined set of gestures, such as described below.

In accordance with one embodiment, that function name or declaration can be considered an interface to the user or application performing device emulation and the actual function bodies, which perform the mapping of outputs from the physical device to outputs of the emulated device, which perform the actual configuration of the selected emulated device, etc., is considered an emulator. In other embodiments, the interface can also comprise any one of a GUI, a voice-operable interface, and a touch-screen.

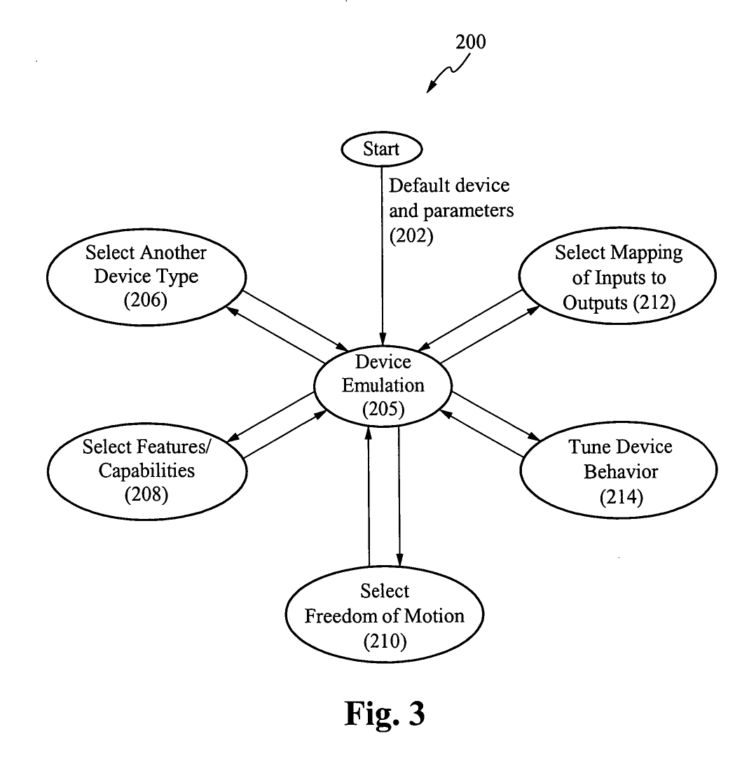

FIG. 3 shows a state diagram 200 for selecting aspects of an emulated device, including the freedom of movement, chosen mappings of user inputs to emulated device outputs, and the ability to tune specific characteristics for a given emulated device, as provided by the functions listed in the Table 170.

Referring to FIGS. 2 and 3, from a start state 202, in which the emulated device is set to a default device and the parameters set to default parameters, the process proceeds to the device emulation state 205. As one example, the default device is a mouse, so that as soon as a system incorporating the invention is turned on, a physical device is automatically used to emulate a mouse. From the device emulation state 205, the process can proceed between the device emulation state 205 and any one of a select mapping state 212, a tuning state 214, a select freedom of motion state 210, a select features/capabilities state 208, and a select device type state 206. In the select freedom of motion state 210, a user (or application) is able to select the type of freedom of motion, to change it from the present setting or device default. The freedom of motion might, for example, be constrained to only the up or down, only left or right, only along diagonals, etc., or combinations thereof. The freedom of motion can also be along a pre-determined path such as a circle or a character. Selecting a freedom of motion corresponds to calling the ATW_selectFreedomOfMotion function with the desired value for motionType.

Within the select mapping state 212, the user is able to specify mappings of user inputs to emulated device outputs. For example, input user motion in the y-direction can be mapped to emulated device output in the x-direction, or as another example, a user gesture can be mapped to cause a left-button mouse click to be output. Other examples include using a gesture to change the selected emulated device, or to change the tuning of the emulated device, or to map x-movement to the size of a circle to be traced out using user motion in the y-direction. It will be appreciated that almost any kind of user input can be mapped to almost any type of emulated device output.

Within the tuning state 214, the user can adjust or tune the emulated device by calling the ATW_tuneDevice function. This could, for example, correspond to scaling the user motion by an integer factor so the emulated device is more or less sensitive to user input. It could also correspond to how much spatial smoothing might be applied to the output. It could also control how a joystick behaves when a finger is removed from a sensor-it could stop, or slow down at a given rate, or keep going indefinitely, etc. It could also correspond to a transposition of user input.

Within the select device type state 206, the user is able to select another device to emulate. This is done by calling ATW_selectDeviceType. Within the select features/capabilities state 208, the user is able to select the capabilities of the emulated device. This is done by calling ATW_selectCapabilities.

FIG. 4 shows a system 180 for displaying data generated by a computer program and for selecting, emulating and configuring an input device, all in accordance with one embodiment of the present invention. The system 180 comprises a host computer 105 comprising a display screen 106 for displaying a graphical user interface (GUI) 150. The GUI 150 comprises an output area 110, a first selection area 115 labeled “Device Type” (the Device Type area 115) and a second selection area 120 labeled “Features” (the Features area 120). It will be appreciated that other features can be included in the GUI 150. The system 180 also comprises a finger sensor 141 and a computer mouse 155, both coupled to the host computer 105 through device drivers and other components known to those skilled in the art. In one embodiment, the GUI 150 is an interface to and is used to call the set of functions listed in Table 170 shown in FIG. 2.

Referring to FIGS. 2-4, the mouse 155 has been used to select the circle labeled “Scroll Wheel” in the Device Type area 115, which in turn calls the ATW_selectDeviceType function, thereby enabling the finger sensor 141 (the physical device) to function as a scroll wheel (the emulated device). The output area 110 displays text generated by a software program executing on the system 180, such as a word processing program. As shown in FIG. 4, the line 130 is at the top-most portion of the output area 110. By vertically swiping a finger 161 across a surface of the finger sensor 141, so that it travels from the position labeled 161, to the position 161′, and then to the position 161″ (in the y-direction 163, shown in the accompanying axes), the finger sensor 141 emulates a scroll wheel. The word processing program receives the emulated scroll wheel output to scroll up the text in area 110. Thus, after the finger 161 has traveled to the position 160″, the line 132 is at the top-most portion of the output area 110.

When the circle labeled “Scroll Wheel” in the Device Type area 115 is selected, positional data generated by the finger sensor 141 is translated into positional data corresponding to that generated by a scroll wheel: “up” and “down” positional data, but not “left” and “right.” The translation of positional data generated by a finger sensor into positional data generated by a scroll wheel, as well as other electronic input devices, is described in more detail in U.S. patent application Ser. No. 10/873,393, titled “System and Method for a Miniature User Input Device,” and filed Jun. 21, 2004, which has been incorporated by reference above.

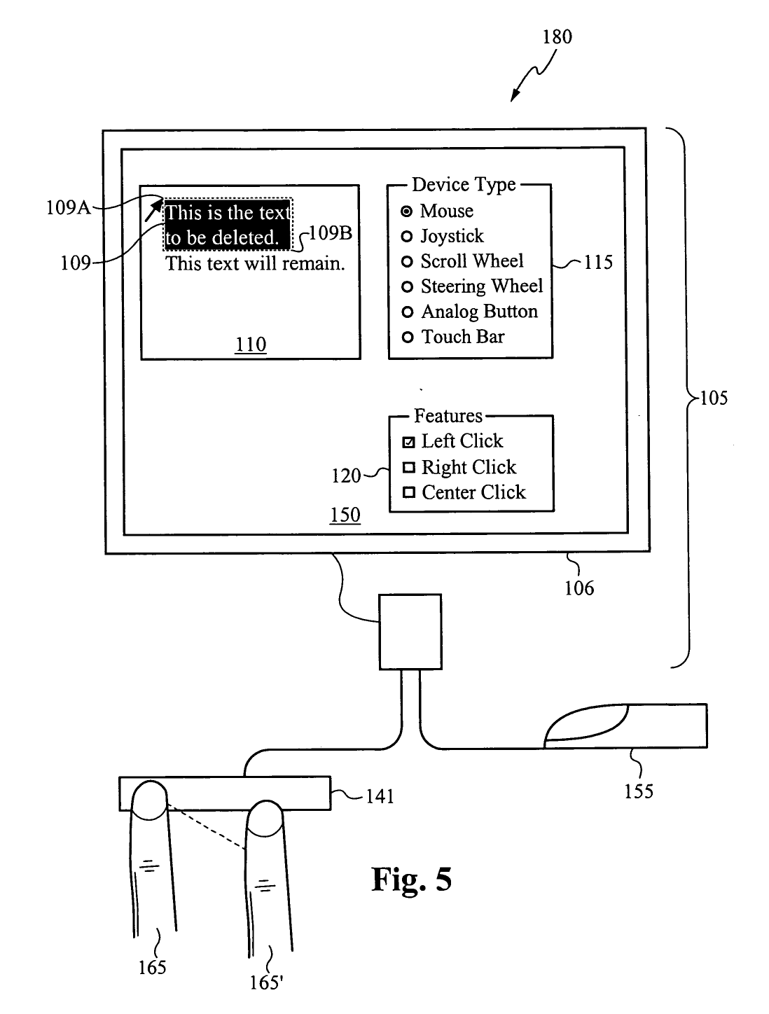

Still referring to FIGS. 2-4, a user is able to use the system 180 to easily select another emulated input device that the finger sensor 140 also emulates. A non-exhaustive list of these emulated devices is shown in the Device Type box 115. FIG. 5 shows the system 180 after the radio box labeled “Mouse” in the Device Type area 115 is selected. Preferably, the radio box labeled “Mouse” is selected using the mouse 155, though it will be appreciated that the radio box labeled “Mouse” can be selected using other means, such as by using a touch screen, a voice-operable selection mechanism, or through the user's finger motion on the finger imaging sensor 140 itself. Each time a user selects a different input device, ATW_selectDeviceType (171, FIG. 2) is called with the desired device (using the appropriate value for deviceTypeToEmulate), causing the emulation to begin.

In the example shown in FIG. 5, the finger sensor 141 has been selected to emulate a mouse. In accordance with the present invention, the emulated mouse can be configured to perform the operations of any conventional mouse. The GUI 150 can be used to configure the emulated mouse so that outputs generated by the finger sensor 141 are translated to mouse inputs having features selected though the GUI 150. In the Features area 120 of FIG. 5, for example, the check box labeled “Left Click” has been checked. Thus, manipulating the finger sensor 140 in a pre-determined way will emulate a left-button mouse click. Using a finger sensor to emulate mouse operations such as left- and right-button mouse clicks, drag-and-drop, and double mouse clicks, to name a few operations, is further described in U.S. patent application Ser. No. 11/056,820, titled “System and Method of Emulating Mouse Operations Using Finger Image Sensors,” and filed Feb. 10, 2005, which is hereby incorporated by reference. Each time the user disables or enables a feature, the ATW_selectCapabilities function (173, FIG. 2) is called with the set of features the user wishes to enable.

It will be appreciated that not all features displayed in the Features area 120 will correspond to an emulated device. For example, when the emulated device is a joystick, the “left click” feature will not apply and thus will not be activated. Even if ATW_selectCapabilities is called to specifically enable a left click, it will not be enabled and an error condition may be returned. In some embodiments, the Features area 120 will display only those features used by the selected emulated device. In these embodiments, for example, when the emulated device is a mouse, the Features area 120 will display the mouse features “Left Click,” “Right Click”, and “Center Click.” When a joystick is later selected as the emulated device, the Features area 120 will not display the mouse features but may display other selectable features corresponding to a joy stick.

Still referring to FIG. 5, a finger on the finger sensor 141 is moved along a surface of the finger sensor 140 so that a cursor is positioned at the location 109A in the output area 110. The finger at the position labeled 165 is tapped on the finger sensor 141 to emulate clicking a left-button of a mouse. The system 180 thus generates a left-button mouse event, thereby selecting the first edge of an area that outlines the text to be selected. The finger is next slid to the position labeled 165′ on the finger sensor 141, thereby causing a corresponding movement of the on-screen cursor to the location 109B of the output area 110. Again the finger is tapped on the surface of the finger sensor 141, thereby selecting the second edge of the area that outlines the text to be selected. The finger sensor 141 has thus been used to emulate a mouse. The selected text is shown in the area 110 as white lettering with a dark background. The selected text is now able to be deleted, cut-and-pasted, dragged-and-dropped, or otherwise manipulated as with normal mouse operations.

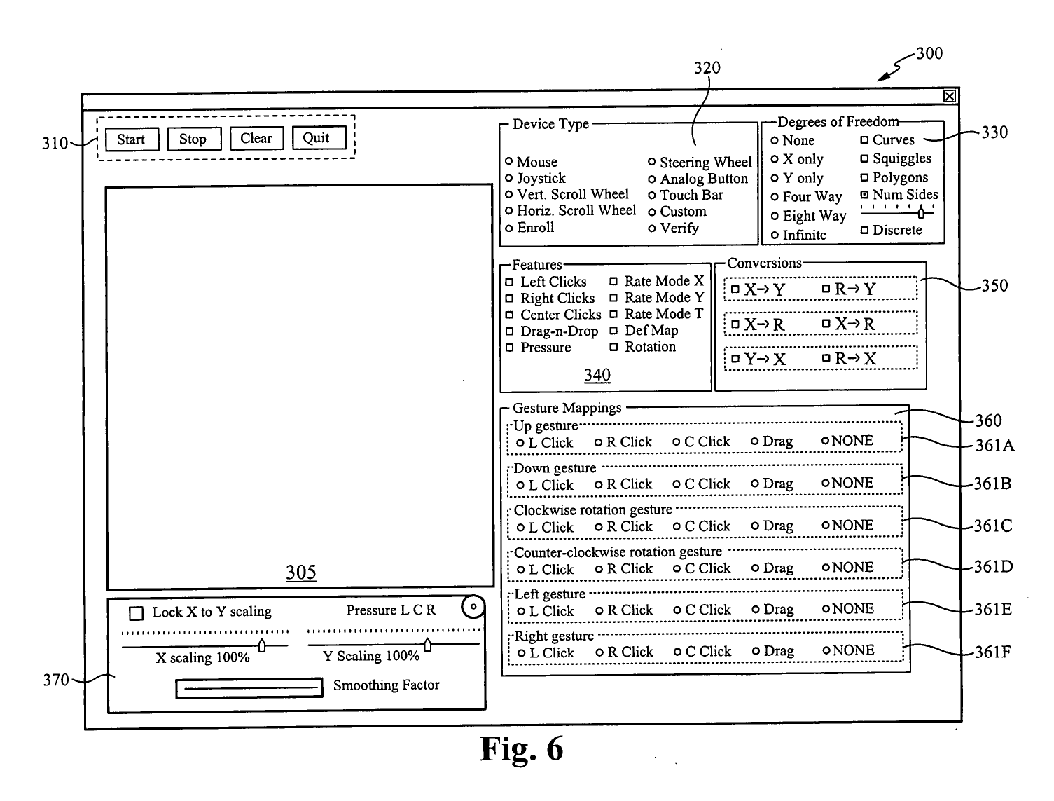

FIG. 6 shows a GUI 300 in accordance with an embodiment of the present invention the corresponds to the state machine illustrated in FIG. 3. The GUI 300 is displayed on the system 180 of FIG. 5. The GUI 300 comprises a Display area 305, a Control area 310, a Device Type area 320, a Degree of Freedom area 330, a Features area 340, a Conversions area 350, a Gesture Mappings area 360, and a Scaling area 370. The Device Type area 320 is similar to the Device Type area 115 of FIGS. 4 and 5, but also includes radio boxes for selecting the emulated devices Vertical Scroll Wheel, Horizontal Scroll Wheel, and Custom, as well as Enroll and Verify radio boxes. By selecting the Enroll check box, a user is able to enroll in the system so that his fingerprint is recognized by the system. When the Verify check box is selected, the user sets the system so that it verifies the identity of a user (e.g., by comparing his fingerprint image to fingerprint images contained in a database of allowed users) before allowing the user to access the system or other features supported or controlled by the application. The enroll and verify device types are not navigational devices in the conventional sense, but they are still considered types of user input devices, where the input is a fingerprint image. In an alternative embodiment, the user's finger is also able to be uniquely identified from a database of enrolled fingerprint templates, thereby emulating an “identify” device type.

Buttons in the Control area 310 include a Start button that activates the selected emulated device, a Stop button that deactivates the selected emulated device, a Clear button that clears any parameters associated with the selected emulated device, and a Quit button that closes the GUI 300. The Degrees of Freedom area 330 contains radio buttons that determine the number of degrees of freedom for the selected emulated device. For example, the emulated device can have zero (None) degrees of freedom, a single degree of freedom in the x-direction (X only), a single degree of freedom in the y-direction (Y only), and, when the emulated device is a joy stick, degrees of freedom corresponding to a joy stick (Four Way, Eight Way, Infinite). As described in more detail below, the Degrees of Freedom area 330 also contains radio boxes for selecting geometric shapes that are drawn in the area 305 when the physical device is manipulated. For example, the geometric shapes include curves, squiggles, and polygons with a selectable number of sides, or discrete sides. The radio boxes in this section correspond to calls to the ATW_selectFreedomOfMotion function (172, FIG. 2) with the desired value for motionType.

The Features area 340 contains features that are selected using corresponding check boxes. The check boxes include Left Clicks, Right Clicks, Center Clicks, and Drag-n-Drop, all selectable when the emulated device is a mouse; Pressure, selectable when the emulated device is an analog button; Rotation, selectable when the emulated device is a steering wheel; Rate Mode X, Rate Mode Y, and Rate Mode T, selectable when the emulated device is a touch bar or any device that generates output at a rate dependent on a pressure or duration that the physical device is manipulated; Def Map, selectable when the output generated by the emulated device can be defined, and used to define what shape is drawn or action taken when a particular gesture is performed; and Rotation, selectable when the emulated device is a steering wheel. The check boxes in the Features are 340 correspond to calls to the ATW_selectCapabilities function (173, FIG. 2) with the appropriate value for setOfCapabilities.

The Conversions area 350 is used to convert movements on the finger sensor 141 of FIG. 5. For example, selecting the radio box labeled “X->Y” maps horizontal movements along the surface of the finger sensor 141 to vertical movements within the area 305; selecting the radio box labeled “X->R” maps horizontal movements along the surface to rotational movements within the area 305; selecting the radio box labeled “Y->X” maps vertical movements along the surface of the finger sensor 155 to horizontal movements within the area 305; selecting the radio box labeled “R->Y” maps rotational movements along the surface of the finger sensor 155 to vertical movements within the area 305; selecting the radio box labeled “Y->R” maps vertical movements along the surface of the finger sensor 155 to rotational movements within the area 305; and selecting the radio box labeled “R->X” maps rotational movements along the surface of the finger sensor 155 to horizontal movements on the area 305. The check boxes in the Conversions area 350 correspond to calls to ATW_mapInputToOutput (174, FIG. 2) where the input is a type of motion (e.g., x, y, or rotation) and the output is another type of motion (e.g., x, y, or rotation).

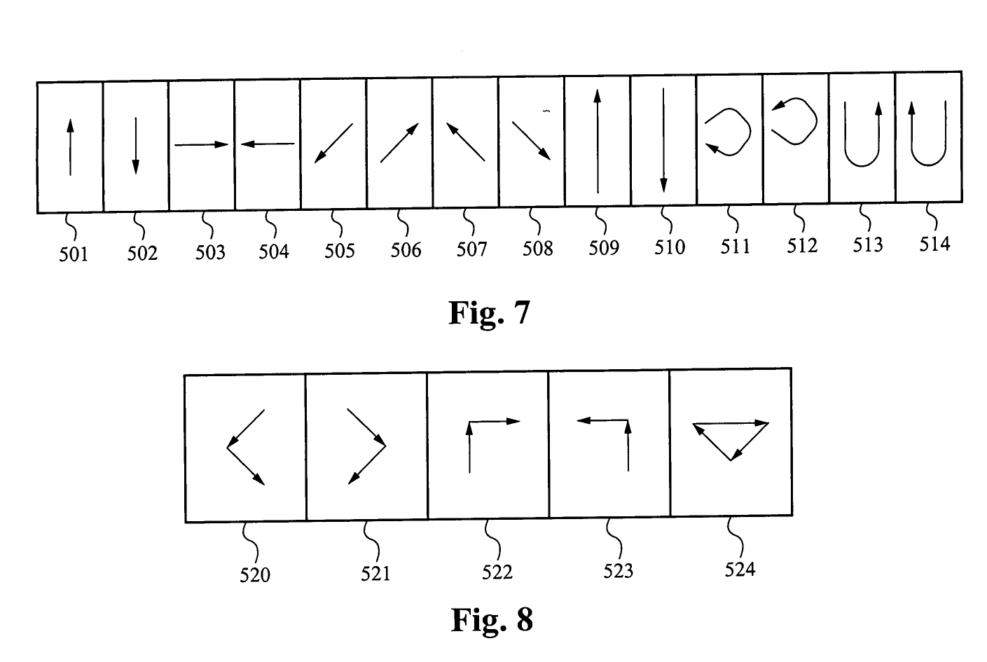

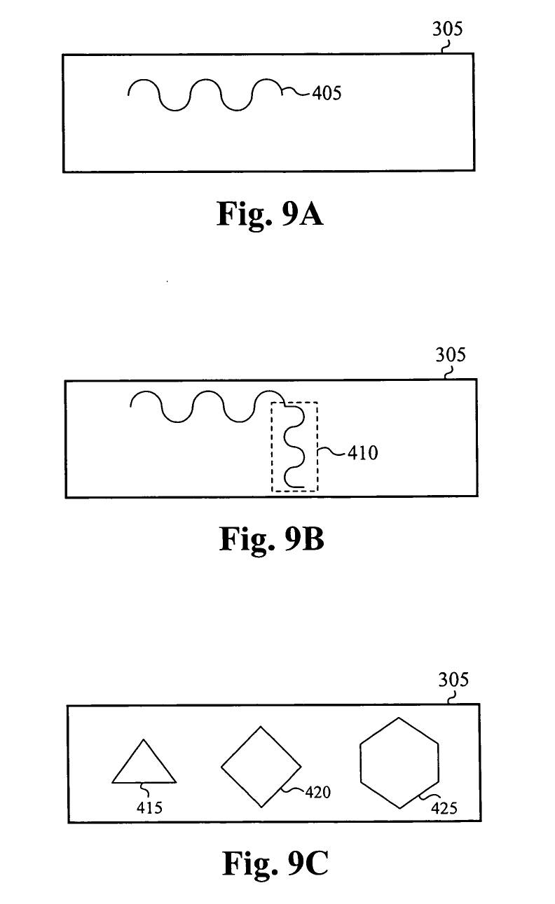

The Gesture Mappings area 360 is used to map motion gestures made along the surface of the finger sensor 141 to generate shapes or physical device events (e.g., mouse click events) within the area 305. As used herein, a gesture refers to any pre-defined movement along the surface of the finger sensor 141, such as tracing the path of the letter “U.” FIG. 7 shows a non-exhaustive set of simple gestures 501-514, while FIG. 8 shows examples of more complex gestures built from combinations of the simple ones. Referring again to FIG. 6, the gesture box 361A labeled “Up gesture” is exemplary of the gesture boxes 361A-F. Referring to the gesture box 361A, a user is able to map an “up gesture” (swiping a finger along the finger sensor 141 in a pre-defined “up” direction) to a mouse left-, right-, or -center button click, to a mouse drag operation, or to no (NONE) operation. A single gesture can thus be mapped to any type of operation of an emulated device. It will also be appreciated that a single gesture is able to be mapped to any predetermined behavior of the program using it. For example, a gesture can be mapped to the drawing of a pre-defined shape. Gestures can be mapped to changes in the device type being emulated (e.g., deviceTypeToEmulate, 171 FIG. 2), so that one could switch between a mouse and a joystick by performing the gesture. In a text input application, different gestures can be mapped to different punctuation types, such as “!” or “,”, or could be used to control whether the entered character is upper- or lower-case. Gestures can also be mapped to entry of certain characters with, optionally, pre-determined font styles. For example, a U-shaped gesture could enter the character “U” into a text document, such as the word processing document shown in the area 110 in FIGS. 4 and 5.

A gesture can also involve the absence of motion. For example, if the user does not touch the sensor for at least a predetermined amount of time, such as 5 seconds, that is able to be defined as a gesture. As another example, a user holding his finger steady on the sensor for at least a predetermined amount of time without moving it is also considered a gesture. The amount of time in each case can range from a few milliseconds to minutes. In other embodiments, tapping on the sensor is also considered a gesture, with a mouse click being the mapped output.

Other examples include mapping a gesture to exiting a software program, executing an entirely new software program, or unlocking a secret. In another example, gestures can change the tuning or freedom of motion of the emulated device. In a media player application, for example, gestures can be used to fast forward, stop, play, skip tracks on, or rewind the medium, or choose the next song, etc. Using finger images to launch software programs are taught in U.S. patent Ser. No. 10/882,787, titled “System for and Method of Finger Initiated Actions,” filed Jun. 30, 2004, which is hereby incorporated by reference.

As still other examples, a system in accordance with the present invention is coupled to or forms part of a host device, such as a personal computer, a personal digital assistant, a digital camera, an electronic game, a photo copier, a cell phone, a digital video player, and a digital audio player. For example, referring to FIG. 1, the elements 140 and 103 together form the host device. Gestures made on a physical device, such as a finger sensor, can be mapped to functions to turn on or off the host device, to adjust a feature of the host device (e.g., zoom in, when the host device is a camera), etc.

In the preferred embodiment, simple gestures are recognized by checking whether the user has input a motion that is long enough within an amount of time that is short enough, and that the path of the motion is close enough to the expected motion comprising the gesture. For instance, an up-gesture would be defined as moving at least Pmin units along a surface of a finger sensor, and no more than Pmax units, within Tmin milliseconds, with a deviation from an ideal straight upward vector of no more than Emax. Typically, Pmin is between 1 and 1000 millimeters of finger movement, and Pmax is greater than Pmin by anywhere from 0 to 1000 millimeters. Typically, Tmin is in a range from 1 to 5000 milliseconds. Emax has a value between 0-50% using the mean-square error estimate well known to those skilled in the art. In an alternative embodiment, a gesture optionally requires that the finger be removed from the finger sensor within some predetermined amount of time after the gesture is entered in order to be recognized or have any effect. In still another embodiment, a finger tap or series of taps is recognized as a single gesture or a series of gestures.

It will be appreciated that values for Pmin, Pmax, Tmin, Smax, and Emax are for illustration only. Other values for each can also be used in accordance with the present invention.

More complex gestures 520-524 shown in FIG. 8 can be recognized as combinations of the simpler gestures 501-514 shown in FIG. 8A. In a preferred embodiment, the simpler gestures must occur in succession with no more than Smax milliseconds elapsing between them. For example, referring to the gesture 521, a “>” is recognized as a down, rightward diagonal gesture followed immediately by a down, leftward diagonal gesture. Smax can range anywhere between 0 and 5000 milliseconds. Alternative embodiments include much larger values of Smax as long as the finger has not been removed from the finger sensor.

The complex gestures 520-524 (FIG. 8) can also be used to enter characters. For instance, the letter “A” could be recognized as three simple gestures in succession: a left downward diagonal (505, FIG. 7) followed by a right downward diagonal (508, FIG. 7) followed by a left (or right) gesture (504 or 503, FIG. 7).

In one embodiment, drawings made in response to gesture mappings are generated the same way that squiggles and polygons, for example, are drawn: a pre-defined set of emulated device events are stored in a memory and emitted when the gesture is recognized. Thus, for example, when the physical device is a finger sensor, the emulated device is a mouse, and a gesture is mapped to the drawing of a circle, performing the gesture on the finger sensor generates the mouse event of selecting the center of the circle using a single click, selecting a pre-determined radius of the circle, and generating mouse clicks that result in the drawing of the circle.

Still referring to FIG. 6, the Tuning area 370 is used to tune various settings of the device being emulated. X-scaling and y-scaling can be selected independently, for example, to make the cursor move a longer or a shorter distance based on the same physical user motion. Sliders in the Tuning area 370 correspond to calling ATW_tuneDevice (175, FIG. 2) with the selected value for parameterToTune (e.g., x-scaling factor) and desired setting (e.g., 200%).

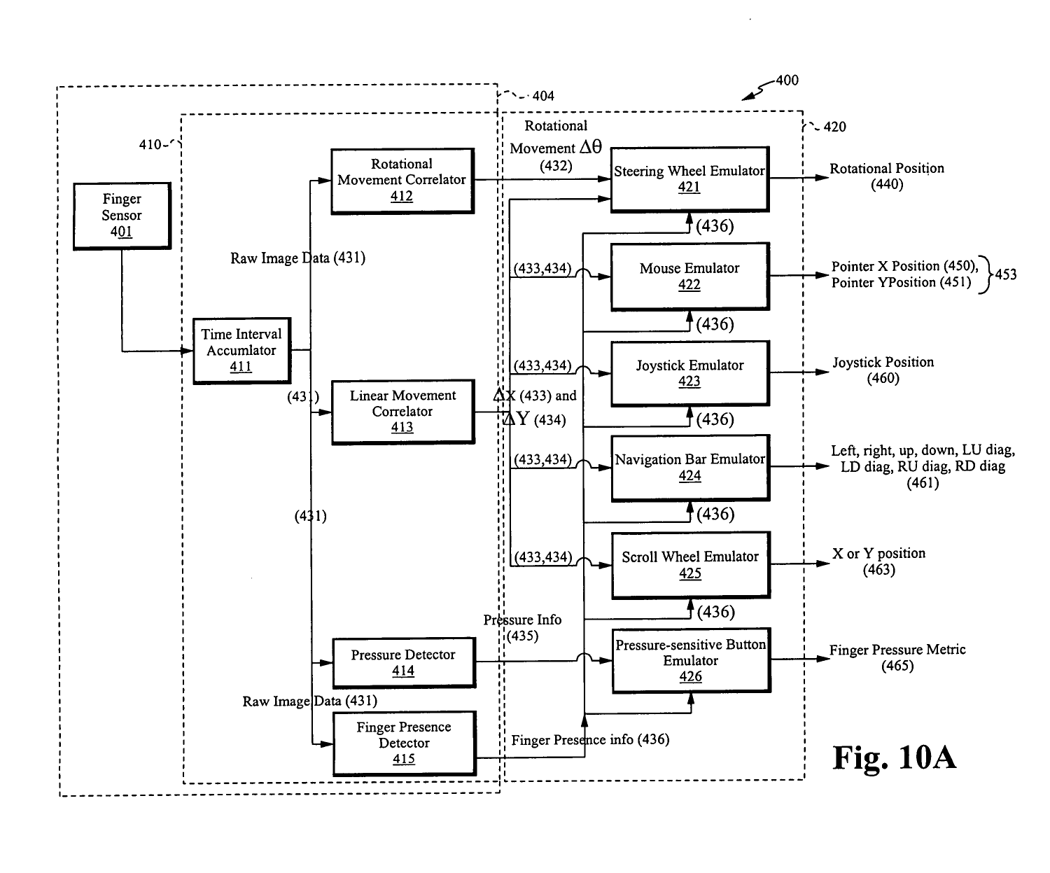

Referring to FIGS. 4, 6, and 9A-C, embodiments of the present invention not only emulate electronic input devices by generating events such as mouse events; embodiments also provide shortcuts by generating shapes by mapping movements on the surface of the finger sensor 141 of FIG. 4 to pre-defined shapes. For example, FIGS. 9A-C show shapes that are drawn within the area 305 when a user checks the Custom radio box in the Device Type area 320 and one of the radio boxes labeled “Curves,” “Squiggles,” and “Polygons” in the Degrees of Freedom area 330. In a first example, a user selects the Custom radio box and the squiggles radio box. By swiping a finger along the finger sensor 141 in a horizontal direction (162, FIG. 4), the horizontal squiggle 405 shown in FIG. 9A is drawn in the area 305. Next, by swiping a finger along the finger sensor 155 in a vertical direction (163, FIG. 4), the vertical squiggle shown in the box 410 of FIG. 9B is drawn in the area 305. Similarly, after selecting the Custom radio box and the polygons radio box, and sliding the slider labeled “Num sides” to three, as shown in FIG. 9C the triangle 415 is drawn in the area 305. Still referring to FIG. 9C, by sliding the slider labeled “Num sides” to 4, the quadrilateral 420 is drawn, and by sliding the slider labeled “Num sides” to 6, the 6-sided polygon 425 is drawn. In these cases, x movement, y movement, or both of the finger is transformed into movement along the perimeter of any of these predetermined shapes. The size of the drawn shape is able to be modified through finger motion as well. For instance, x-motion is used to modify the radius of the pre-determined circle, and y-motion is used to trace it out, thus making the drawing of spirals possible.

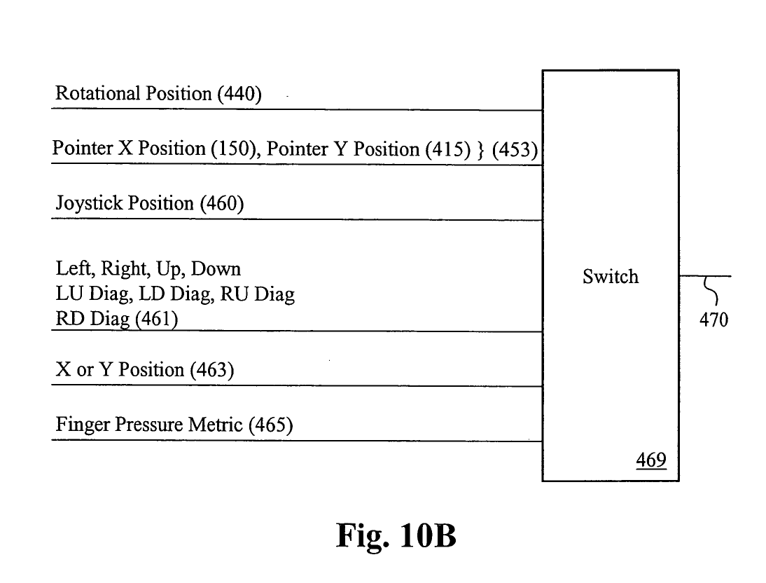

FIGS. 10A and 10B show one embodiment of a component of a system for selecting a device to emulate device in accordance with the present invention. The portion of the system labeled 400 is, except for labeling, identical to the computer system 100 illustrated in FIG. 1 of the patent application Ser. No. 10/873,393, titled “System and Method for a Miniature User Input Device,” which is incorporated by reference above. FIG. 10A shows a finger sensor 401 coupled to an emulator 440 for generating the outputs (440, 453, 460, 461, 463, and 465) of several emulated devices. As described in more detail in the '393 application, the emulator 440 comprises a group of instruments 410 and a computing platform 420. The group of instruments 410 comprises a time interval accumulator 111 coupled to a rotational movement correlator 412, a linear movement correlator 413, a pressure detector 414, and a finger presence detector 415.

The computing platform 420 comprises a steering wheel emulator unit 421 with a rotational position output 440, a mouse emulator unit 412 with a mouse output 453 comprising a pointerX position output 450 and a pointerY position output 451, a joystick emulator unit 423 with a joystick position output 460, a navigation bar emulator unit 424 with a navigation output 461, a scroll wheel emulator unit 425 with an scroll wheel output 463, and a pressure-sensitive button emulator unit 426 with a PressureMetric output 465. Systems and methods for processing rotational movements are described in U.S. patent application Ser. No. 10/912,655, titled “System for and Method of Generating Rotational Inputs,” and filed Aug. 4, 2004, which is incorporated by reference.

FIG. 10B shows the outputs 440, 453, 460, 461, 463, and 465 coupled to a switch 469 (e.g., a multiplexer) that selects one of the outputs 470 that is ultimately routed to a host computer (not shown). Preferably, the components 420 and 469 are both software modules. Alternatively, the components 420 and 469 are hardware components or a combination of hardware and software components. Referring now to FIGS. 2, 5, 10A, and 10B, it will be appreciated that selecting a emulated device in the Device Type area 115 calls the ATW_selectDeviceType function, which activates the switch 469 to route the output of the emulated device along the line 470. For example, by selecting the radio box labeled “Mouse” in the Device Type area 115 of FIG. 5, the switch 449 routes the output 453 (outputs corresponding to the emulated device, here a mouse) along the line 470, thereby routing mouse signals to an application executing on the host computer. Signals from the physical device (the finger sensor 141) is thus used to emulate a mouse.

While the preferred embodiment describes an application programming interface for selecting and configuring emulated devices, and while FIGS. 4-6 all show a graphical user interface for performing similar functions, it will be appreciated that other interfaces can also be used. Furthermore, while the above examples describe a finger swipe sensor, such as a capacitive, thermal, or optical swipe sensor, as the physical device, it will be appreciated that finger placement sensors can also be used.

It will also be appreciated that physical devices other than finger sensors can be used in accordance with the present invention. As one example, a track ball is the physical device and is used to emulate a joy stick. In accordance with the present invention, rolling the track ball at a 45 degree angle will emulate the output of an 8-position joy stick moved to a 45 degree angle.

It will be readily apparent to one skilled in the art that various modifications may be made to the embodiments without departing from the spirit and scope of the invention as defined by the appended claims.

We claim:

1. A system comprising:
a. an interface for selecting an electronic input device from a plurality of electronic input devices; and
b. an emulator coupled to the interface for emulating the electronic input device.

2. The system of claim 1, wherein the interface comprises an application program interface to a set of functions.

3. The system of claim 2, wherein the set of functions includes a function for selecting a device type corresponding to the electronic input device.

4. The system of claim 3, wherein the device type is any one of a mouse, a scroll wheel, a joystick, a steering wheel, an analog button, a pressure sensor, and a touch bar.

5. The system of claim 3, wherein the device type is any one of an enroll type, a verify type, and an identify type.

6. The system of claim 2, wherein the set of functions includes a function for setting a characteristic of the electronic input device.

7. The system of claim 6, wherein the characteristic of the electronic input device comprises any one of a type of motion, a set of capabilities, a mapping of an input of a physical device to an output of the electronic input device, and a setting for tuning a parameter of the electronic input device.

8. The system of claim 7, wherein the type of motion comprises any one or more of a motion in a linear direction only, a motion in a predetermined number of linear directions only, and a motion corresponding to one of a geometric shape and a pre-determined arbitrary shape.

9. The system of claim 8, wherein the geometric shape is any one of a circle, a rectangle, a square, a triangle, and a periodic shape.

10. The system of claim 8, wherein the arbitrary shape is a character in a standard alphabet.

11. The system of claim 7, wherein the set of capabilities comprises any one or more of a mouse button operation, a drag-and-drop operation, a pressure, a rotation, a rate mode in a linear direction, and a rate mode in an angular direction.

12. The system of claim 11, wherein the input to the physical device is any one of a motion in a first linear direction and a gesture, and further wherein the output of the electronic input device is any one of a motion in a second linear direction, a motion in an angular direction, and a mouse button operation.

13. The system of claim 1, further comprising a physical device coupled to the interface, the physical device for generating an output.

14. The system of claim 13, wherein the physical device comprises a finger sensor.

15. The system of claim 14, wherein the finger sensor is a finger swipe sensor.

16. The system of claim 15, wherein the finger swipe sensor is any one of a capacitive sensor, a thermal sensor, and an optical sensor.

17. The system of claim 14, wherein the finger sensor is a finger placement sensor.

18. The system of claim 13, wherein the physical device is any one of a track ball, a joystick, and a mouse.

19. The system of claim 13, wherein the physical device is configured to receive a gesture, whereby the generated output corresponds to any one of a change to a device type, a change to a freedom of motion, a character, and a control signal for operating a host device coupled to the emulator.

20. The system of claim 19, wherein operating the host device comprises launching a software program on the host device.

21. The system of claim 7, wherein the parameter of the electronic device is any one of a scaling in a linear direction and a scaling in an angular direction.

22. The system of claim 2, wherein the interface further comprises a graphical user interface for invoking the set of functions.

23. The system of claim 2, wherein the interface comprises a command line interface.

24. The system of claim 1, further comprising a host device for receiving an output of the electronic input device.

25. The system of claim 24, wherein the host device is one of a personal computer, a personal digital assistant, a digital camera, an electronic game, a printer, a photo copier, a cell phone, a digital video disc player, and a digital audio player.

26. A system comprising:
a. means for selecting an electronic input device from a plurality of electronic input devices; and
b. means for emulating the electronic input device.

27. The system of claim 26, wherein the plurality of electronic input devices comprise any two or more of a mouse, a scroll wheel, a joy stick, a steering wheel, an analog button, a pressure sensor, and a touch bar.

28. The system of claim 26, further comprising a physical input device.

29. The system of claim 28, wherein the physical input device comprises a finger swipe sensor.

30. A system comprising:
a. a physical device for receiving a gesture; and
b. a translator coupled to the physical device, the translator for translating the gesture into a selectable one of an output of an electronic input device and a defined entry.

31. The system of claim 30, wherein the entry corresponds to launching an application executing on a host device.

32. The system of claim 30, wherein the electronic input device is selectable from a plurality of electronic input devices.

33. The system of claim 32, wherein the plurality of electronic input devices comprise any two of a mouse, a scroll wheel, a joy stick, a steering wheel, an analog button, a pressure sensor, and a touch bar.

34. The system of claim 30, wherein the entry corresponds to a change to any one or more of a type of the electronic input device, a change to a freedom of motion of the electronic input device, and a generation of a pre-determined character by the electronic input device.

35. The system of claim 30, wherein the physical device comprises a finger sensor.

36. The system of claim 35, wherein the finger sensor is a swipe sensor.

37. The system of claim 30, wherein the physical device is one of a track ball and a mouse.

38. The system of claim 30, wherein the entry corresponds to any one of a character and a punctuation mark.

39. The system of claim 30, wherein entry corresponds to an input to operate a host device.

40. The system of claim 39, wherein the input to operate the host device corresponds to any one of powering on and powering off the host device.

41. The system of claim 39, wherein the host device is any one of a personal computer, a personal digital assistant, a digital camera, an electronic game, a photo copier, a cell phone, a digital video player, and a digital audio player.

42. The system of claim 39, wherein the application is a media application coupled to a medium and the input to operate the host device corresponds to any one of fast forwarding the medium, rewinding the medium, playing the medium, stopping the medium, and skipping tracks on the medium.

43. A method of generating an input for an electronic device comprising:
a. performing a gesture on a physical device; and
b. translating the gesture into a selectable one of an output of an electronic input device and a defined entry.

44. The method of claim 43, wherein the entry corresponds to one of a punctuation mark, a character, a command, changes in a type of a device emulated by the physical device, changes in a feature of a device emulated by the physical device.

45. The method of claim 43, wherein the physical device comprises a finger sensor.

46. The method of claim 45, wherein the finger sensor is a swipe sensor.

47. The method of claim 43, wherein the physical device is one of a track ball and a mouse.

48. The method of claim 44, wherein the command is used to operate a host device.

49. The method of claim 48, wherein operating the host device comprises controlling power to the host device.

50. The method of claim 48, wherein the host device is one of a personal computer, a personal digital assistant, a digital camera, an electronic game, a printer, a photo copier, a cell phone, a digital video player, and a digital audio player.

51. The method of claim 48, wherein the host device comprises a medium and operating the host device comprises one of fast forwarding the medium, rewinding the medium, and skipping to a track on the medium.

52. A method of emulating an electronic input device comprising:
a. selecting an electronic input device to be emulated from a plurality of electronic input devices;
b. receiving an input on a physical device; and
c. translating the input from the physical device to an output corresponding to the electronic input device, thereby emulating the electronic input device.

53. The method of claim 52, wherein the plurality of electronic input devices comprise any two or more of a mouse, a scroll wheel, a joy stick, a steering wheel, an analog button, and a touch bar.

54. The method of claim 52, wherein receiving the input on the physical device comprises contacting a finger sensor.

55. The method of claim 54, wherein contacting the finger sensor comprises swiping a patterned object along a surface of the finger sensor.

56. The method of claim 52, further comprising selecting a characteristic of the electronic input device.

57. The method of claim 56, wherein the characteristic corresponds to a mapping between a user input and an output used for emulating the electronic input device.

58. The method of claim 52, wherein the output corresponding to the electronic input device is for operating a host device.

59. The method of claim 52, wherein the input comprises a gesture.

60. The method of claim 58, wherein the host device is one of a personal computer, a personal digital assistant, a digital camera, an electronic game, a printer, a photo copier, a cell phone, a digital video disc player, and a digital audio player.
